(19) United States
(12) Patent Application Publication
(10) Pub. No.: US 2016/0018998 A1
(43) Pub. Date: Jan. 21, 2016

(54) Methods and Systems for Scalable Reliability Management of Non-Volatile Memory Modules

(71) Applicant: SanDisk Enterprise IP LLC, Milpitas, CA (US)

(72) Inventors: Vidyabhushan Mohan, San Jose, CA (US); Jack Edward Frayer, Boulder Creek, CA (US)

(21) Appl. No.: 14/597,161

(22) Filed: Jan. 14, 2015

Related U.S. Application Data
(60) Provisional application No. 62/025,849, filed on Jul. 17, 2014.

(51) Int. Cl. G06F 3/06

(52) U.S. Cl. CPC G06F 3/0619; G06F 3/0653; G06F 3/0659; G06F 3/0679

(57) ABSTRACT

The various implementations described herein include systems, methods and/or devices used to perform a method of reliability management of data in a storage device having a plurality of memory modules. The method includes receiving or accessing a host command to perform a specified operation on a portion of non-volatile memory within a storage device. The method also includes, at a storage controller for the storage device, identifying a module of the plurality of modules, in accordance with the host command. The method includes, at the identified module, retrieving health information for the portion of non-volatile memory within the identified module, modifying one or more memory operation parameters in accordance with the specified operation and the retrieved health information, and executing the specified operation on the portion of non-volatile memory in the identified module in accordance with the one or more modified memory operation parameters.

### RELATED APPLICATIONS

This application claims priority to U.S. Provisional Patent Application No. 62/025,849, filed Jul. 17, 2014, which is hereby incorporated by reference in its entirety.

### TECHNICAL FIELD

The disclosed embodiments relate generally to memory systems, and in particular, to enable reliability data management of storage devices (e.g., memory devices).

### BACKGROUND

Semiconductor memory devices, including flash memory, typically utilize memory cells to store data as an electrical value, such as an electrical charge or voltage. A flash memory cell, for example, includes a single transistor with a floating gate that is used to store a charge representative of a data value. Flash memory is a non-volatile data storage device that can be electrically erased and reprogrammed. More generally, non-volatile memory (e.g., flash memory, as well as other types of non-volatile memory implemented using any of a variety of technologies) retains stored information even when not powered, as opposed to volatile memory, which requires power to maintain the stored information. As non-volatile memory devices are scaled to accommodate increasingly large storage capacities, managing the storage and use of reliability data for respective portions of non-volatile memory becomes increasingly burdensome.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to enable reliability data management of storage devices.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1A is a block diagram illustrating an implementation of a data storage system, in accordance with some embodiments.

FIG. 1B is a block diagram illustrating an implementation of a data storage system, in accordance with some embodiments.

FIG. 1C is a block diagram illustrating an implementation of a storage device controller of a data storage system, in accordance with some embodiments.

FIG. 2A is a block diagram illustrating an implementation of a non-volatile memory module, in accordance with some embodiments.

FIG. 2B is a block diagram illustrating an implementation of a management module of a storage device controller, in accordance with some embodiments.

FIGS. 3A-3C contain a flowchart representation of a method of managing reliability information of non-volatile memory devices in a storage device, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The various implementations described herein include systems, methods and/or devices used to enable reliability data management of storage devices. Some implementations include systems, methods and/or devices to retrieve, use or update health information for a portion of non-volatile memory in a storage device.

As the electronics industry progresses, the memory storage needs for electronic devices ranging from smart phones to server systems are rapidly growing. For example, as enterprise applications mature, the capacity of storage devices required for these applications have dramatically increased. As the capacity has increased, correspondingly, the number of non-volatile memory chips inside the storage devices has also increased. As a result of the number of memory chips increasing, the centralized hardware resources inside these storage devices are under higher demand to manage the reliability of the memory.

In order to effectively manage the reliability of non-volatile memories in storage devices, some implementations described herein use scalable techniques of managing reliability data for non-volatile memory (NVM) modules, where each non-volatile memory module includes one or more memory chips. In some implementations, a storage device includes one or more non-volatile memory modules. For example, as memory storage needs increase, a single storage device increases its memory capacity by adding one or more additional non-volatile memory modules.

In some implementations, each non-volatile memory module in the storage device includes a multi-functional circuit block hereinafter referred to as a non-volatile memory (NVM) controller. In some implementations, an NVM controller is a hardware unit having a processor (e.g., implemented as an ASIC) and an optional cache memory within a multi-chip module. In some embodiments, the memory module includes cache memory outside of the NVM controller. As an example of one of its functions, an NVM controller manages the reliability data (e.g., die health information, identification of bad sectors, etc.) of the memory chips within a particular NVM module and thereby reduces the work needed to be done by a storage controller of the storage device. Thus, in some implementations, by freeing up the central resources in the storage controller from reliability management, the storage controller can provide higher performance for other operations in the storage device, without sacrificing management of memory reliability.

More specifically, some implementations include a method of reliability management of data in a storage device (e.g., a non-volatile memory device) that includes a plurality of non-volatile memory modules. In some implementations, the method includes processing a host command, the host command specifying an operation to be performed on a portion of non-volatile memory within a non-volatile memory device, by identifying, at a storage controller for the non-volatile memory device, an NVM module of the plurality of NVM modules, in accordance with the host command. The method includes, at the identified NVM module, retrieving health information for the portion of non-volatile memory within the identified NVM module, modifying one or more memory operation parameters in accordance with the specified operation and the retrieved health information, and executing the specified operation on the portion of non-volatile memory in the identified NVM module in accordance with the one or more modified memory operation parameters.

In some embodiments, the health information for the portion of non-volatile memory is stored in non-volatile memory within the NVM module. In some embodiments, the health information for the portion of non-volatile memory includes one or more of the following with respect to the portion: the number of cycles required for the last program or erase operation, the last time an operation of any type was performed, the last time an operation of a particular type was performed, the duration of execution of the last operation, the duration of execution of the last operation of a particular type, the average duration of execution of all operations, the number of bit errors detected during a last read operation (or the cumulative number of bit errors detected since a predefined event), the location of bit errors in the portion, the number of memory operations (e.g., read, write and/or erase) performed and the number of operations of a particular type performed in the portion.

In some embodiments, the one or more memory operation parameters include one or more of: write operation voltage, write operation step voltage, dynamic read parameters and operation-dependent bias voltages.

In some embodiments, the method further includes, at the identified NVM module, updating the health information for the portion of non-volatile memory, after executing the specified operation. In some embodiments, this includes measuring one or more health metrics of the portion of non-volatile memory and assigning a score to the portion of non-volatile memory in accordance with the one or more measured health metrics and in accordance with one or more health metric thresholds. In some embodiments, the method further includes conveying health information stored within the NVM module to the storage controller, and in accordance with a determination that the storage device is experiencing a power fail condition, transferring at least a subset of the health information from volatile memory in the NVM module to non-volatile memory.

In some embodiments, the storage device includes a plurality of controllers.

In some embodiments, the plurality of controllers on the storage device include a memory controller and one or more flash controllers, the one or more flash controllers coupled by the memory controller to a host interface of the storage device.

In some embodiments, the plurality of controllers on the storage device include at least one non-volatile memory (NVM) controller and at least one other memory controller other than the at least one NVM controller.

In some embodiments, the storage device includes a dual in-line memory module (DIMM) device.

In some embodiments, one of the plurality of controllers on the storage device maps double data rate (DDR) interface commands to serial advance technology attachment (SATA) interface commands.

In some embodiments, the portion of non-volatile memory is an erase block. In some embodiments, the storage device includes one or more three-dimensional (3D) memory devices and circuitry associated with operation of memory elements in the one or more 3D memory devices. In some embodiments, the circuitry and one or more memory elements in a respective 3D memory device, of the one or more 3D memory devices, are on the same substrate. In some embodiments, the storage device includes one or more flash memory devices.

In another aspect, any of the methods described above are performed by a storage device including (1) an interface for coupling the storage device to a host system, (2) a storage controller having one or more processors, the storage controller configured to: (A) receive a host command specifying an operation to be performed on a portion of non-volatile memory within the storage device, (B) identify an NVM module of the plurality of NVM modules, in accordance with the host command, and (3) an NVM module having one or more processors, the NVM module configured to: (A) retrieve health information for the portion of non-volatile memory within the identified NVM module, (B) modify one or more memory operation parameters in accordance with the specified operation and the retrieved health information, and (C) execute the specified operation on the portion of non-volatile memory in the identified NVM module in accordance with the one or more modified memory operation parameters.

In some embodiments, the storage device is configured to perform any of the methods described above.

In yet another aspect, any of the methods described above are performed by a storage device. In some embodiments, the device includes (A) means for coupling the storage device to a host system, (B) means for receiving a host command specifying an operation to be performed on a portion of non-volatile memory within the storage device, (C) means for identifying an NVM module of the plurality of NVM modules, in accordance with the host command, and (D) means, in the identified NVM module, for retrieving health information for the portion of non-volatile memory within the identified NVM module, (E) means, in the identified NVM module, for modifying one or more memory operation parameters in accordance with the specified operation and the retrieved health information, and (F) means, in the identified NVM module, for executing the specified operation in accordance with the one or more modified memory operation parameters.

In yet another aspect, any of the methods described above are performed by a storage device that includes an interface for coupling the storage device to a host system, a plurality of NVM modules, each NVM module including two or more non-volatile memory devices, and a storage controller having one or more processors. The storage controller includes a command module to receive or access a host command specifying an operation to be performed on a portion of non-volatile memory within the storage device, and a map module to identify an NVM module of the plurality of NVM modules, in accordance with the host command. The identified NVM module includes a health management module for retrieving health information for the portion of non-volatile memory within the identified NVM module, a memory operation configuration module to modify one or more memory operation parameters in accordance with the specified operation and the retrieved health information, and an execution module to execute the specified operation on the portion of non-volatile memory, in the identified NVM module, in accordance with the one or more modified memory operation parameters.

In some embodiments, the storage device is configured to perform any of the methods described above.

In yet another aspect, a non-transitory computer readable storage medium stores one or more programs for execution by one or more processors of a storage device, the one or more programs including instructions for performing any one of the methods described above.

In some embodiments, the storage device includes a plurality of controllers, and the non-transitory computer readable storage medium includes a non-transitory computer readable storage medium for each controller of the plurality of controllers, each having one or more programs including instructions for performing any one of the methods described above.

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

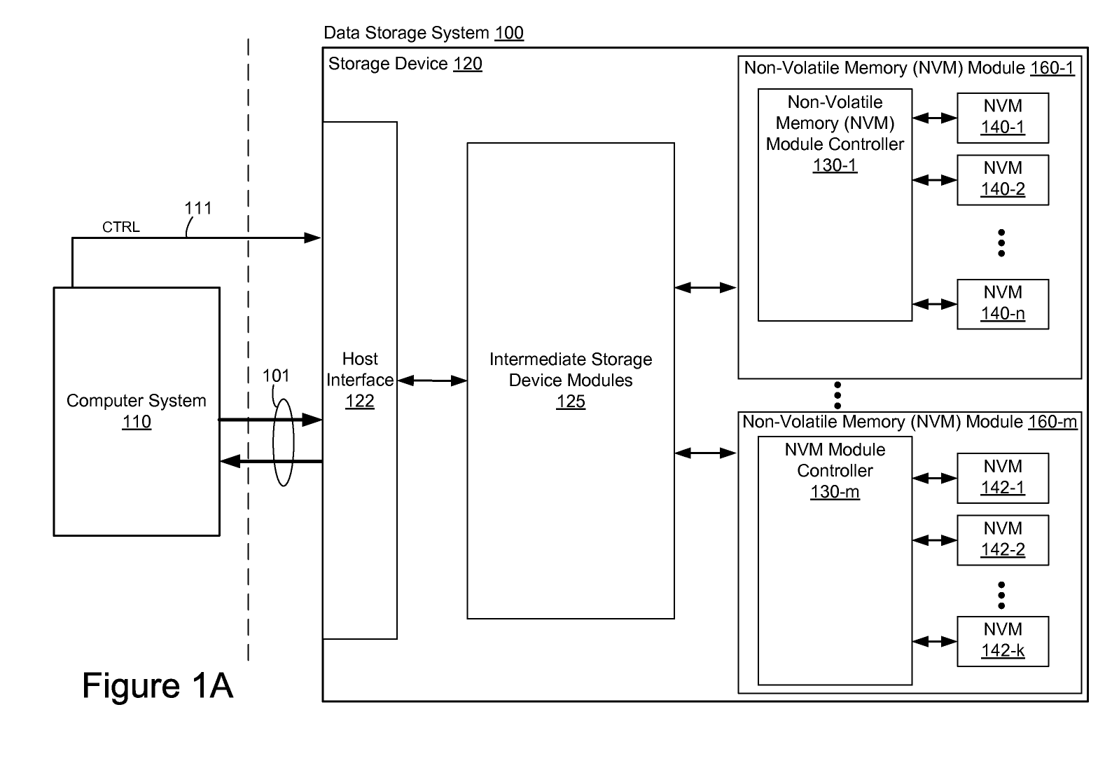

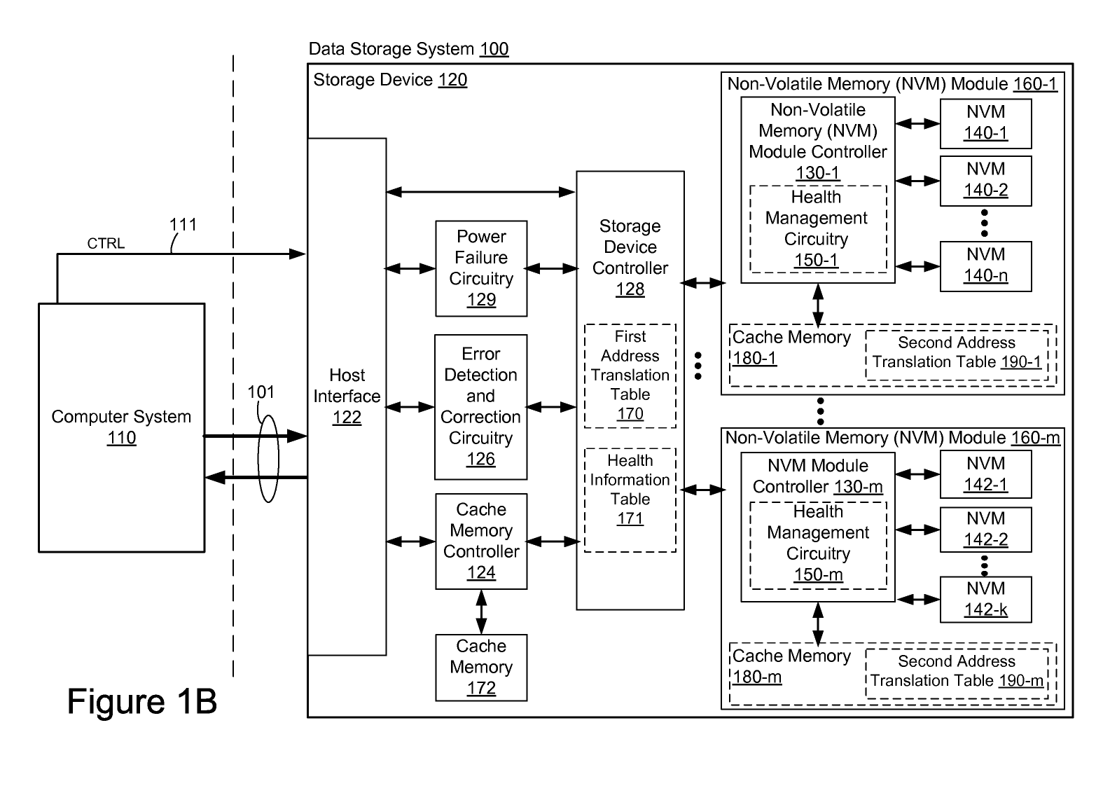

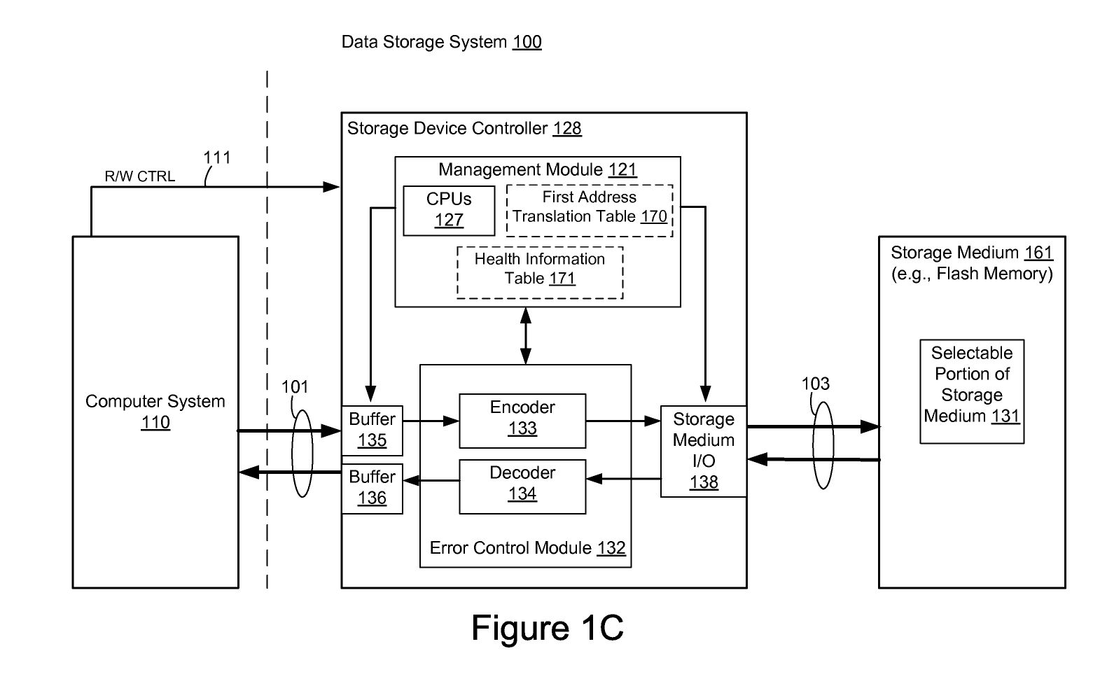

FIG. 1A is a block diagram illustrating an implementation of a data storage system 100, in accordance with some embodiments. While some example features are illustrated, various other features have not been illustrated for the sake of brevity and so as not to obscure more pertinent aspects of the example implementations disclosed herein. To that end, as a non-limiting example, data storage system 100 includes storage device 120, which includes host interface 122, intermediate modules 125 and one or more NVM modules (e.g., NVM modules(s) 160). Each NVM module 160 includes one or more NVM module controllers (e.g., NVM module controllers 130-1 through 130-m), and one or more NVM devices (e.g., one or more NVM device(s) 140, 142).

In some implementations, each NVM module controller 130 includes one or more processing units (also sometimes called CPUs, processors, microprocessors, microcontrollers or ASICs) configured to execute instructions in one or more programs stored in memory coupled to or embedded in the NVM module controller 130. In some embodiments, NVM devices 140, 142 are coupled to NVM module controllers 130 through connections that convey commands in addition to data, and optionally convey metadata, error correction information and/or other information in addition to data values to be stored in NVM devices 140, 142 and data values read from NVM devices 140, 142.

In some embodiments, storage device 120 is configured for enterprise storage suitable for applications such as cloud computing, or for caching data stored (or to be stored) in secondary storage, such as hard disk drives. In some other embodiments, storage device 120 is configured for relatively smaller-scale applications such as personal flash drives or hard-disk replacements for personal, laptop and tablet computers. Although flash memory devices and flash controllers are used as an example here, storage device 120 may include any other NVM device(s) and corresponding NVM controller(s).

In some embodiments, each NVM device 140, 142 is divided into a number of addressable and individually selectable blocks. In some implementations, the individually selectable blocks are the minimum size erasable units in a flash memory device. In other words, each block contains the minimum number of memory cells that can be erased simultaneously. Each block is usually further divided into a plurality of pages and/or word lines, where each page or word line is typically an instance of the smallest individually accessible (readable) portion in a block. In some implementations (e.g., using some types of flash memory), the smallest individually accessible unit of a data set, however, is a sector, which is a subunit of a page. That is, a block includes a plurality of pages, each page contains a plurality of sectors, and each sector is the minimum unit of data for reading data from the flash memory device.

In some implementations, each block includes a number of pages, for example, 64 pages, 128 pages, 256 pages or another suitable number of pages. Blocks are typically grouped into a plurality of zones. Each block zone can be independently managed to some extent, which increases the degree of parallelism for parallel operations and simplifies management of each NVM device 140, 142.

In this non-limiting example, data storage system 100 is used in conjunction with computer system 110. In some implementations, storage device 120 includes a single NVM device while in other implementations storage device 120 includes a plurality of NVM devices. In some implementations, NVM devices 140, 142 include NAND-type flash memory or NOR-type flash memory. Further, in some implementations, NVM module controller 130 is or includes a solid-state drive (SSD) controller. However, one or more other types of storage media may be included in accordance with aspects of a wide variety of implementations.

Computer system 110 is coupled to storage device 120 through data connections 101. However, in some implementations computer system 110 includes storage device 120 as a component and/or sub-system. Computer system 110 may be any suitable computer device, such as a personal computer, a workstation, a computer server, or any other computing device. Computer system 110 is sometimes called a host or host system. In some implementations, computer system 110 includes one or more processors, one or more types of memory, optionally includes a display and/or other user interface components such as a keyboard, a touch screen display, a mouse, a track-pad, a digital camera and/or any number of supplemental devices to add functionality. Further, in some implementations, computer system 110 sends one or more host commands (e.g., read commands and/or write commands) on control line 111 to storage device 120. In some implementations, computer system 110 is a server system, such as a server system in a data center, and does not have a display and other user interface components.

In some implementations, intermediate modules 125 include one or more processing units (also sometimes called CPUs or processors or microprocessors or microcontrollers) configured to execute instructions in one or more programs. Intermediate modules 125 are coupled to host interface 122 and NVM modules 160, in order to coordinate the operation of these components, including supervising and controlling functions such as power up, power down, data hardening, charging energy storage device(s), data logging, communicating between modules on storage device 120 and other aspects of managing functions on storage device 120.

Flash memory devices, such as NVM 140, 142, utilize memory cells to store data as electrical values, such as electrical charges or voltages. Each flash memory cell typically includes a single transistor with a floating gate that is used to store a charge, which modifies the threshold voltage of the transistor (i.e., the voltage needed to turn the transistor on). The magnitude of the charge, and the corresponding threshold voltage the charge creates, is used to represent one or more data values. In some implementations, during a read operation, a reading threshold voltage is applied to the control gate of the transistor and the resulting sensed current or voltage is mapped to a data value.

The terms “cell voltage” and “memory cell voltage,” in the context of flash memory cells, means the threshold voltage of the memory cell, which is the minimum voltage that needs to be applied to the gate of the memory cell's transistor in order for the transistor to conduct current. Similarly, reading threshold voltages (sometimes also called reading signals and reading voltages) applied to a flash memory cells are gate voltages applied to the gates of the flash memory cells to determine whether the memory cells conduct current at that gate voltage. The value stored in a flash memory cell is determined by determining which read voltages, in a set of predefined read voltages, when applied to the gate of a memory cell cause the memory cell to conduct current and which do not.

FIG. 1B is a block diagram illustrating an implementation of a data storage system 100, in accordance with some embodiments. To avoid needless repetition of explanations already provided above, features and components of data storage system 100 already shown in FIG. 1A and described above, and shown again in FIG. 1B, are not described again here, and instead only additional features and components are described with respect to FIG. 1B.

As a non-limiting example, storage device 120 includes cache memory controller 124, error detection and correction circuitry 126, power failure circuitry 129, and storage device controller 128, which correspond generally to intermediate storage device modules 125 of FIG. 1A. Storage device 120 may include various additional features that have not been illustrated for the sake of brevity and so as not to obscure more pertinent features of the example implementations disclosed herein, and a different arrangement of features may be possible.

In some implementations, error detection and correction circuitry 126 is used to detect and in some implementations, correct data errors in one or more of the NVM devices (e.g., NVM device(s) 140, 142). In some embodiments, the error detection and correction circuitry 126 includes one or more state machines to carry out a particular error detection and correction methodology, or one or more processing units (also sometimes called CPUs or processors or microprocessors or microcontrollers) configured to execute instructions in one or more programs (e.g., in error detection and correction circuitry 126). In some embodiments, error detection and correction circuitry 126 uses one or more error detection and/or correction schemes, such as low density-parity check (LDPC) or Bose Chaudhuri Hocquenghem (BCH). Error detection and correction circuitry 126 is coupled to storage device controller 128, and in some embodiments, to host interface 122 and/or NVM modules 160 in order to coordinate the error detection and correction operations of these components, including as non-limiting examples one or more of: encoding data with error detection and correction codes, decoding data (including detecting and correction errors in the data) read from one or more NVM devices (e.g., NVM device(s) 140, 142), reporting errors to the host computer system 110, and sending error information to storage device controller 128.

In some embodiments, power failure circuitry 129 is used to detect a power failure condition in storage device 120 and trigger data hardening operations, and provide backup power to one or more components of storage device 120. In some embodiments, storage device controller 128 coordinates power failure operations within storage device 120, sending instructions to NVM controllers to store data (e.g., metadata, and data in flight) in volatile memory to non-volatile memory, and optionally providing power failure information to host computer system 110.

In some embodiments, cache memory controller 124 transfers data to and from cache memory 172 located on storage device 120 or external to storage device 120. In some embodiments, the cache memory 172 controlled by cache memory controller 124 is volatile memory.

Storage device controller 128 is coupled to host interface 122 and NVM modules 160. In some implementations, storage device controller 128 is also coupled to one or more intermediate modules such as error detection and correction circuitry 126, power failure circuitry 129 and cache memory controller 124. In some implementations, during a write operation, storage device controller 128 receives data from computer system 110 through host interface 122 and during a read operation, storage device controller 128 sends data to computer system 110 through host interface 122. Further, host interface 122 provides additional data, signals, voltages, and/or other information needed for communication between storage device controller 128 and computer system 110. In some embodiments, storage device controller 128 and host interface 122 use a defined interface standard for communication, such as double data rate type three for synchronous dynamic random access memory (DDR3), serial advance technology attachment (SATA), serial attached SCSI (SAS), or other storage interface.

In some implementations, storage device controller 128 includes one or more processing units (also sometimes called CPUs or processors or microprocessors or microcontrollers) configured to execute instructions in one or more programs (e.g., in storage device controller 128). In some embodiments, storage device controller 128 includes a first address translation table 170. In some embodiments, first address translation table 170 is a logical to physical address table that includes one or more first subsets of respective physical addresses (e.g., the first 30 bits of each physical address to which a logical address is mapped by storage device 120, including the first 30 bits of a first 36-bit physical address and the first 30 bits of a second 36-bit physical address). In some embodiments, the first subset of a respective physical address stored in first address translation table 170 is or includes a predefined number of most significant bits (e.g., 30 bits) of a respective physical address in one of the NVM devices (e.g., NVM devices 140, 142). In some embodiments, storage device controller 128 includes health information table 171, which retains health and/or reliability information regarding one or more portions of non-volatile memory (e.g., in NVM devices 140, 142). Examples of health and/or reliability information include one or more of the following with respect to the portion: the number of cycles required for the last program or erase operation, the last time an operation of any type was performed, the last time an operation of a particular type was performed, the duration of execution of the last operation, the duration of execution of the last operation of a particular type, the average duration of execution of all operations, the number of bit errors detected during a last read operation (or the cumulative number of bit errors detected since a predefined event), the location of bit errors in the portion, the number of memory operations (e.g., read, write and/or erase) performed and the number of operations of a particular type performed in the portion.

As described in FIG. 1A, in some implementations, each NVM module of NVM modules 160 include one or more NVM module controllers (e.g., NVM module controllers 130-1 through 130-m). In some implementations, each NVM module controller 130 includes health management circuitry 150. In some embodiments, health management circuitry 150 stores or manages the storage and retrieval of health and/or reliability information for one or more portions of non-volatile memory within a respective NVM module (e.g., NVM module 160). For example, health management circuitry 150-1 manages storage of health information for NVM devices 140-1 to 140-n, on a block-by-block basis. In some embodiments, the health management circuitry 150 includes local storage for health and/or reliability information corresponding to one or more portions of non-volatile memory, and in some embodiments, the health management circuitry 150 stores the health and/or reliability information in a dedicated portion of non-volatile memory within one of the NVM devices in the respective NVM module (e.g., NVM device 140-1 in NVM module 160-1), or within cache memory of the NVM module (e.g., cache memory 180-1). Examples of health and/or reliability information include at least the same examples as described above with respect to health information table 171. In some embodiments, health information table 171 includes a subset of the health and/or reliability information stored in a respective NVM module 160.

In some embodiments, one or more programs to operate the health management circuitry 150 are loaded or updated by the storage controller (e.g., storage device controller 128, FIG. 1B). In some embodiments this loading or updating occurs during firmware initialization, during power up, during idle operation of the storage device or during normal operation of the storage device. In some embodiments, the health management circuitry 150 is implemented using a hardware state machine, and in some embodiments the health management circuitry 150 is implemented using an ASIC.

In some embodiments, the NVM modules 160 each include a portion of cache memory (e.g., cache memory 180). In some embodiments, NVM modules 160 store a second address translation table (e.g., second address translation table 190) and in some embodiments, the second address translation table 190 is stored in the cache memory 180 for a respective NVM module 160. In some embodiments, upon occurrence of a power fail condition in storage device 120 (e.g., detected by power failure circuitry 129), the contents of cache memory 180, including second address translation table 190 are transferred to non-volatile memory (e.g., on one or more of NVM devices 140, 142). In some embodiments, second address translation table 190 is a logical to physical address table that includes one or more second subsets of respective physical addresses (e.g., the last 6 bits each physical address to which a logical address is mapped in the NVM module, including the last 6 bits of a first 36-bit physical address and the last 6 bits of a second 36-bit physical address). In some embodiments, the second subset of a respective physical address stored in second address translation table 190 includes a predefined number of least significant bits (e.g., 6 bits) of the respective physical address. In some embodiments, the second address translation table 190 is stored in content addressable memory. In some embodiments, the second address translation table 190 is stored in a byte-addressable persistent memory that provides for faster read and/or write-access than other memory devices within NVM modules 160.

FIG. 1C is a diagram of an implementation of a data storage system 100, in accordance with some embodiments. To avoid needless repetition of explanations already provided above, features and components of data storage system 100 already shown in FIGS. 1A and 1 B and described above, and shown again in FIG. 1C, are not described again here, and instead only additional features and components are described with respect to FIG. 1C.

While some example features are illustrated, various other features have not been illustrated for the sake of brevity and so as not to obscure more pertinent aspects of the example implementations disclosed herein. To that end, as a non-limiting example, the data storage system 100 includes a storage device controller 128, and a storage medium 161, and is used in conjunction with a computer system 110. In some implementations, storage medium 161 is a single flash memory device while in other implementations storage medium 161 includes a plurality of flash memory devices (e.g., in one or more NVM module(s) 160, as shown in FIG. 1A or FIG. 1B). In some implementations, storage medium 161 is NAND-type flash memory or NOR-type flash memory. Further, in some implementations storage device controller 128 is a solid-state drive (SSD) controller. However, other types of storage media may be included in accordance with aspects of a wide variety of implementations.

Storage medium 161 is coupled to storage device controller 128 through connections 103. Connections 103 are sometimes called data connections, but typically convey commands in addition to data, and optionally convey metadata, error correction information and/or other information in addition to data values to be stored in storage medium 161 and data values read from storage medium 161. In some implementations, however, storage device controller 128 and storage medium 161 are included in the same device as components thereof. Additional features and functions of storage medium 161, including selectable portions such as selectable portion 131, are described above with respect to NVM devices 140, 142 in the discussion of FIG. 1A.

In some implementations, storage device controller 128 includes a management module 121, an input buffer 135, an output buffer 136, an error control module 132 and a storage medium interface (I/O) 138. Storage device controller 128 may include various additional features that have not been illustrated for the sake of brevity and so as not to obscure more pertinent features of the example implementations disclosed herein, and that a different arrangement of features may be possible. Input and output buffers 135,136 provide an interface to computer system 110 through data connections 101. Similarly, storage medium I/O 138 provides an interface to storage medium 161 though connections 103. In some implementations, storage medium I/O 138 includes read and write circuitry, including circuitry capable of providing reading signals to storage medium 161 (e.g., reading threshold voltages for NAND-type flash memory).

In some implementations, management module 121 includes one or more processing units (CPUs, also sometimes called processors) 127 configured to execute instructions in one or more programs (e.g., in management module 121). In some implementations, the one or more processing units 127 are shared by one or more components within, and in some cases, beyond the function of storage device controller 128. Management module 121 is coupled to input buffer 135, output buffer 136 (connections not shown), error control module 132 and storage medium I/O 138 in order to coordinate the operation of these components. In some embodiments, the management module 121 includes first address translation table 170, as described earlier with respect to FIG. 1B. In some embodiments, the management module 121 includes health information table 171, as described earlier with respect to FIG. 1B.

Error control module 132 is coupled to storage medium I/O 138, input buffer 135 and output buffer 136. Error control module 132 is provided to limit the number of uncorrectable errors inadvertently introduced into data. In some embodiments, error control module 132 includes an encoder 133 and a decoder 134. Encoder 133 encodes data by applying an error control code to produce a codeword, which is subsequently stored in storage medium 161. In some embodiments, when the encoded data (e.g., one or more codewords) is read from storage medium 161, decoder 134 applies a decoding process to the encoded data to recover the data, and to correct errors in the recovered data within the error correcting capability of the error control code. For the sake of brevity, an exhaustive description of the various types of encoding and decoding algorithms generally available and known to those skilled in the art is not provided herein.

During a write operation, input buffer 135 receives data to be stored in storage medium 161 from computer system 110. In some embodiments, the data held in input buffer 123 is made available to encoder 126, which encodes the data to produce one or more codewords. The one or more codewords are made available to storage medium I/O 138, which transfers the one or more codewords to storage medium 161 in a manner dependent on the type of storage medium being utilized. In some embodiments, during the write operation, data from input buffer 135 or the one or more codewords are sent to the management module 121. In some embodiments, the management module looks up health and/or reliability management data in health information table 171 regarding the physical location of the memory in storage medium 161 where the data or one or more codewords is to be written. For example, the health and/or reliability information indicates whether the write operation is to be performed on a particularly weak block, or a particularly robust block. In some embodiments, this health information is made available, along with the data or one or more codewords to storage medium I/O 138, which transfers this information to storage medium 161 in a manner dependent on the type of storage medium being utilized.

In some embodiments, during the write operation, data from input buffer 135 or the one or more codewords are sent to the management module 121. In some embodiments, the management module looks up a first subset of a respective physical address for the write operation from first address translation table 170 (e.g., the first 24 bits of a 37-bit address). In some embodiments, this first subset of a respective physical address is made available, along with the data or one or more codewords to storage medium I/O 138, which transfers this information to storage medium 161 in a manner dependent on the type of storage medium being utilized. In some embodiments, information is received by the management module 121 after the write operation is performed, from storage medium 161 via storage medium I/O 138, to update the first address translation table 170 and/or the health information table 171.

A read operation is initiated when computer system (host) 110 sends one or more host read commands on control line 111 to storage device controller 128 requesting data from storage medium 161. Storage device controller 128 sends one or more read access commands to storage medium 161, via storage medium I/O 138, to obtain raw read data in accordance with memory locations (addresses) specified by the one or more host read commands. In some embodiments, storage medium I/O 138 provides the raw read data (e.g., one or more codewords) to decoder 134. If the decoding is successful, the decoded data is provided to output buffer 136, where the decoded data is made available to computer system 110. In some implementations, if the decoding is not successful, storage device controller 128 may resort to a number of remedial actions or provide an indication of an irresolvable error condition.

In some embodiments, during the read operation, storage device controller 128 sends one or more read access commands along with corresponding health and/or reliability information obtained from health information table 171, to storage medium 161, via storage medium I/O 138. In some embodiments, during the read operation, storage device controller 128 sends one or more read access commands, to storage medium 161, after looking up a first subset of a first physical address in first address translation table 170, to obtain read data in accordance with memory locations (addresses) specified by the one or more host read commands and the first subset of a first physical address.

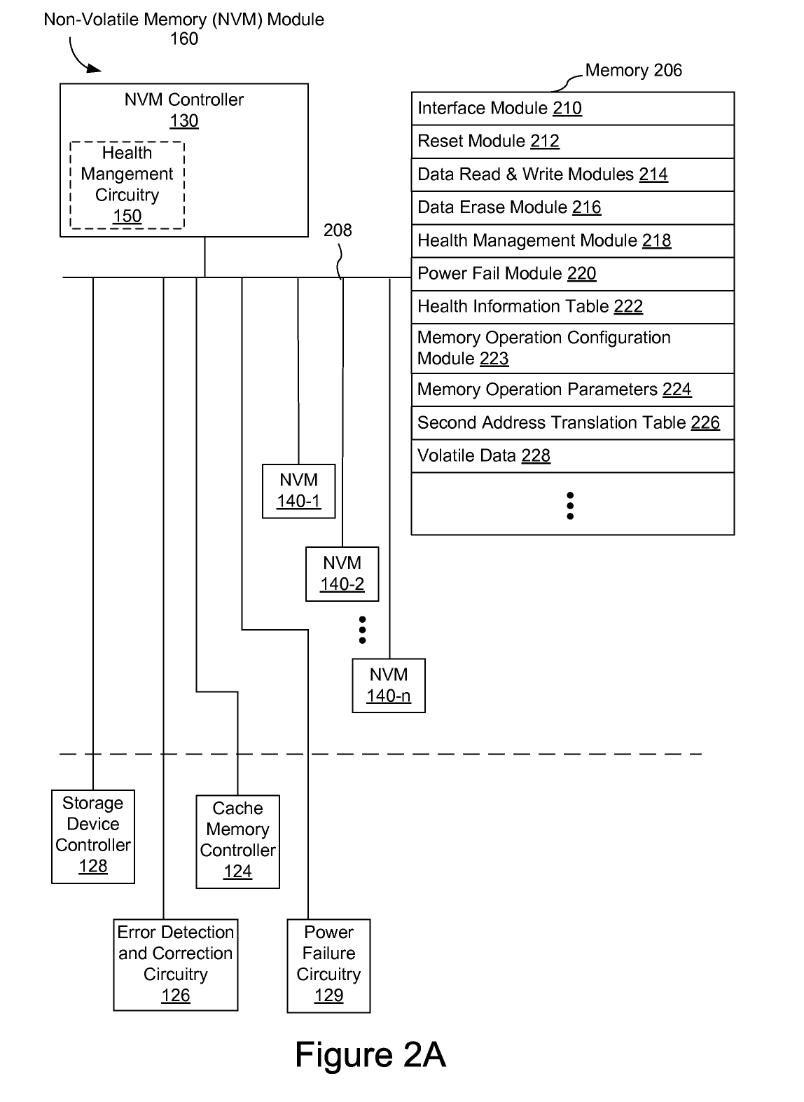

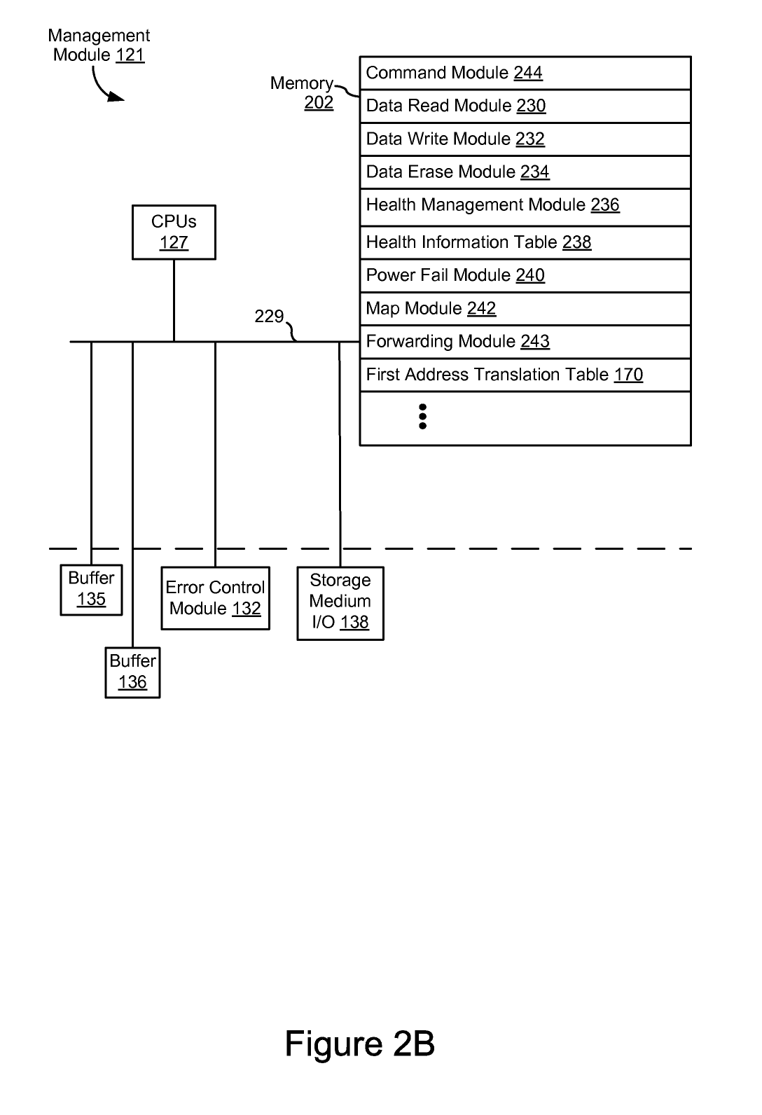

FIG. 2A is a block diagram illustrating an implementation of a respective NVM module 160 (e.g., any one of NVM Module 160-1 to 160-m), in accordance with some embodiments. NVM module 160 typically includes one or more processors (also sometimes called CPUs, processing units, microprocessors, microcontrollers, or controllers), herein called NVM controller 130 (e.g., any one of NVM controller 130-1 to 130-m) for ease of reference, for executing software modules, programs and/or instructions stored in memory 206 and thereby performing processing operations (some of which are described in more detail below), memory 206, and one or more communication buses 208 for interconnecting these components. Stated another way, in some embodiments, NVM controller 130 includes one or more processors. Communication buses 208 optionally include circuitry (sometimes called a chipset) that interconnects and controls communications between system components.

In some implementations, NVM module 160 also includes health management circuitry 150, as described above with reference to FIG. 1B, which works in conjunction with software, such as health management module 216, executed by the one or more processors of NVM module 160. In some other implementations, the health management functions described above with respect to health management circuitry 150, are handled by health management module 216 without health management circuitry.

In some embodiments, NVM module 160 is coupled to storage device controller 128, error detection and correction circuitry 126 (if present), power failure circuitry 129 (if present) and cache memory controller 124 and NVM devices 140 (e.g., NVM devices 140-1 through 140-n) by communication buses 208. Memory 206 includes high-speed random access memory, such as DRAM, SRAM, DDR RAM or other random access solid state memory devices, and may also include NVM, such as one or more magnetic disk storage devices, optical disk storage devices, flash memory devices, or other non-volatile solid state storage devices. Memory 206 optionally includes one or more storage devices remotely located from NVM controller(s) 130, such as memory shared with other NVM modules 160 and/or memory shared with storage device controller 128 (FIG. 1B). Memory 206, or alternately the NVM device(s) within memory 206, comprises a non-transitory computer readable storage medium. In some embodiments, memory 206, or the computer readable storage medium of memory 206 stores the following programs, modules, and data structures, or a subset thereof:

interface module 210 that is used for communicating with other components, such as storage device controller 128, error detection and correction circuitry 126, and NVM devices 140;

reset module 212 that is used for resetting NVM module 160;

one or more data read and write modules 214, sometimes collectively called an execution module or command execution module, used for reading from and writing to NVM devices 140;

data erase module 216 that is used for erasing portions of memory on NVM devices 140;

health management module 218 that is used for obtaining, updating and maintaining health and/or reliability information for portions of memory in the NVM devices 140 (e.g., the NVM devices that are in the same NVM module 160 as NVM controller 130);

power failure module 220 that is used storing data in volatile memory to NVM when a power failure condition has been detected by the storage device (e.g., storage device 120, FIG. 1A); in some implementations, or in some circumstances, execution of power failure module 220 is triggered by a signal or command from storage device controller 128 (FIG. 1B), or power failure circuitry 129 (FIG. 1B);

health information table 222 that stores health and/or reliability information for portions of memory in NVM devices 140;

memory operation configuration module 223 that modifies one or more memory operation parameters 224 in accordance with a specified memory operation and retrieved health information;

memory operation parameters 224 that are used in association with memory operations and data from the health information table to perform memory operations on portions of memory in NVM devices 140;

second address translation table 226 that stores one or more subsets of respective physical memory addresses (e.g., the last 6 bits each such physical address), along with corresponding logical addresses; and

volatile data 228 including volatile data associated with NVM module 160, and in some embodiments information such as health information, memory operation parameters and/or the second address table.

In some embodiments, the health management module 218 includes instructions for operations such as obtaining, updating, maintaining and accessing health and/or reliability information for portions of memory in NVM devices 140. In some embodiments, health management module 218 retrieves data from and stores data to health information table 222 while performing the above identified operations. In some embodiments, health management module 218 retrieves data from and stores data to memory operations parameters 224 while performing the above identified operations.

In some embodiments, prior to performing a memory operation on a portion of NVM devices 140 (e.g., erasing a block), health management module 218 retrieves health and/or reliability information from health information table 222, for the portion. In some embodiments, the health and/or reliability information includes information regarding the portion of NVM memory, such as the number of cycles required for the last program or erase operation, the last time an operation of any type was performed, the last time an operation of a particular type was performed, the duration of execution of the last operation, the duration of execution of the last operation of a particular type, the average duration of execution of all operations, the number of bit errors detected during a last read operation (or the cumulative number of bit errors detected since a predefined event), the location of bit errors in the portion, the number of memory operations (e.g., read, write and/or erase) performed and the number of operations of a particular type performed in the portion.

In some embodiments, the health management module 218 uses the retrieved health information for the respective portion of memory to retrieve one or more memory operation parameters 224, and optionally adjust one or more memory operation parameters with respect to the portion of NVM memory. For example, for a write operation, the health management module 218 retrieves a first parameter for write voltage and a second parameter for write step voltage from memory operation parameters 224, and in accordance with the memory operation (e.g., writing to memory) and health information retrieved from health information table 222, modifies or adjusts the retrieved parameters for the current memory operation (e.g., increasing write voltage from 2V to 2.25V for a block with below average health).

In some embodiments, the aforementioned memory operation parameters include one or more of: a write operation voltage, a write operation step voltage, dynamic read parameters, and various other operation-dependent bias voltages. Rather than have a standard, static set of memory operation parameters, memory operation parameters 224 are adaptable and customizable to one or more portions of NVM devices 140.

In some embodiments, NVM module 160 receives a host command specifying a memory operation (e.g., read a page) to be performed on a portion of NVM devices 140, determines the portion of NVM memory, retrieves health information for that portion, modifies one or more memory operation parameters in accordance with the respective memory operation and the retrieved health information, then performs the respective memory operation using the one or more modified memory operation parameters. In some embodiments, the host command is conveyed to NVM module 160 via storage device controller 128, and in some implementations the host command is converted from a host command format to an internal format, and preprocessed (e.g., by converting one or more logical block addresses in the host command to one or more corresponding physical address prefixes) by storage device controller 128 prior to being conveyed to NVM module 160.

In some embodiments, NVM module 160 updates health information table 222 (e.g., using health management module 218) after performing the respective memory operation. For example, after performing a write operation on a portion of NVM devices 140, NVM module 160-1 increments the count of write operations performed on that portion, stored in the health information table 222.

In some embodiments, second address translation table 226 stores one or more subsets of respective physical memory addresses (e.g., the last 6 bits of a 37-bit physical address), along with corresponding logical addresses. In some embodiments, the contents of second address translation table 226 are used at least in combination with a first address translation table (e.g., first address translation table 170 in FIGS. 1B-1C), and in some embodiments with a third or subsequent address translation table (e.g., having a different subset of the physical address than the first or second address translation tables).

In some embodiments, NVM module 160 receives (or accesses, e.g., on a command queue) a host command (e.g., from storage device controller 128) specifying a memory operation (e.g., read a page) to be performed on a portion of NVM devices 140. The host command includes, or alternatively the NVM module 160 receives along with the host command, a first subset of a physical address for the memory operation (e.g., looked up in first address translation table 170, FIGS. 1B-1C), sometimes herein called the first physical address prefix for ease of reference, and a logical address corresponding to the first physical address prefix. In some embodiments, NVM module 160 uses the first corresponding logical address and the first physical address prefix (e.g., the N (e.g., 32) most significant bits of a Y-bit (e.g., 38-bit) address) to retrieve a second subset of a corresponding physical address (e.g., the 6 least significant bits of a 38-bit address), and determines the complete physical address (e.g., a full 38-bit address) corresponding to the logical address in the host command.

In some embodiments, a memory operation such as a write or erase operation, changes one or more address translation tables in the storage device. For example, in some embodiments, after performing one of these types of memory operations, NVM module 160 updates the second address translation table 226 to indicate a new address mapping or to remove one or more address mappings. In some embodiments this updating is performed by data read and write modules 214 or data erase module 216. In some embodiments, after performing one of these types of memory operations, the first address translation table stored in the storage device controller (e.g., first address translation table 170 in FIGS. 1B-1C), is also updated to reflect the addressing change caused by a memory operation.

In some embodiments, health information table 222, memory operation parameters 224 and/or the second address translation table 226 are stored in volatile memory, such as volatile data 228. In some embodiments, in case of a power fail condition, the power fail module 220 performs a data hardening process that transfers data from volatile data 228 to non-volatile memory (e.g., a portion of NVM devices 140). In some embodiments, the data hardening process performed by power fail module 220 stores health information table 222, memory operation parameters 224 and/or the second address translation table 226 in a portion of NVM memory using a single-layer-cell (SLC) mode of operation to allow for faster and more reliable retrieval and updating. In some embodiments, during normal operation, health information table 222, memory operation parameters 224 and/or the second address translation table 226 are stored in byte-addressable cache memory.

Each of the above identified elements may be stored in one or more of the previously mentioned storage devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above. In some embodiments, the programs, modules, and data structures stored in memory 206, or the computer readable storage medium of memory 206, include instructions for implementing respective operations in the methods described below with reference to FIGS. 4A-4C.

Although FIG. 2A shows NVM module 160 in accordance with some embodiments, FIG. 2A is intended more as a functional description of the various features which may be present in an NVM module than as a structural schematic of the embodiments described herein. In practice, and as recognized by those of ordinary skill in the art, items shown separately could be combined and some items could be separated.

FIG. 2B is a block diagram illustrating an exemplary management module 121 in accordance with some embodiments. Management module 121 typically includes: one or more processing units (CPUs) 127 for executing modules, programs and/or instructions stored in memory 202 and thereby performing processing operations; memory 202; and one or more communication buses 229 for interconnecting these components. One or more communication buses 229, optionally, include circuitry (sometimes called a chipset) that interconnects and controls communications between system components. Management module 121 is coupled to buffer 135, buffer 136, error control module 132, and storage medium I/O 138 by one or more communication buses 229. Memory 202 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 202, optionally, includes one or more storage devices remotely located from the CPU(s) 127. Memory 202, or alternatively the non-volatile memory device(s) within memory 202, comprises a non-transitory computer readable storage medium. In some embodiments, memory 202, or the non-transitory computer readable storage medium of memory 202, stores the following programs, modules, and data structures, or a subset or superset thereof:

command module (sometimes called an interface module) 244, to receive or access a host command specifying an operation to be performed; the host command typically specified a logical address corresponding to a portion of non-volatile memory within the storage device;

data read module 230 for reading data from storage medium 161 (FIG. 1C) comprising flash memory (e.g., one or more flash memory devices, such as NVM devices 140, 142, each comprising a plurality of die);

data write module 232 for writing data to storage medium 161;

data erase module 234 for erasing data from storage medium 161;

health management module 236 used for obtaining, updating and maintaining health and/or reliability information for portions of memory in storage medium 161 (e.g., portions of NVM devices 140, FIG. 1B) stored in memory 202;

health information table 238 that stores health and/or reliability information for portions of memory on storage medium 161 (e.g., portions of NVM devices 140, FIG. 1B);

power fail module 240 used for detecting a power failure condition on the storage device (e.g., storage device 120, FIG. 1A) and triggering storage of data in volatile memory to non-volatile memory, and optionally working with power fail module 220 in an NVM module 160-1 (FIG. 2A);

map module 242 to identify an NVM module of the plurality of NVM modules, in accordance with a host command; in some embodiments, map module 242 maps a specified logical address (e.g., specified by the host command) to a physical address, or to a first subset of the physical address, corresponding to the specified logical address, using first address translation table 170;

forwarding module 243 to forward a command, corresponding to the host command, to the NVM module identified by map module 242; and

first address translation table 170 for associating logical addresses with first subsets of respective physical addresses for respective portions of storage medium 161, FIG. 1C (e.g., a distinct flash memory device, die, block zone, block, word line, word line zone or page portion of storage medium 161).

In some embodiments, health management module 236 is used by the management module 121 for obtaining, updating and maintaining health and/or reliability information for portions of memory on storage medium 161 (e.g., portions of NVM devices 140, FIG. 1B) stored in memory 202. In some embodiments, the health management module 236 initiates a health diagnostic request, for example if health information in health information table 238 has not been updated for a predetermined length of time. In some embodiments, the health management module 236 updates health information table 238 when a memory operation initiated by a host command is performed on a respective portion of NVM memory (e.g., updated after a write operation is performed).

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 202 may store a subset of the modules and data structures identified above. Furthermore, memory 202 may store additional modules and data structures not described above. In some embodiments, the programs, modules, and data structures stored in memory 202, or the non-transitory computer readable storage medium of memory 202, provide instructions for implementing any of the methods described below with reference to FIGS. 4A-4C.

Although FIG. 2B shows a management module 121, FIG. 2B is intended more as functional description of the various features which may be present in a management module than as a structural schematic of the embodiments described herein. In practice, and as recognized by those of ordinary skill in the art, the programs, modules, and data structures shown separately could be combined and some programs, modules, and data structures could be separated.

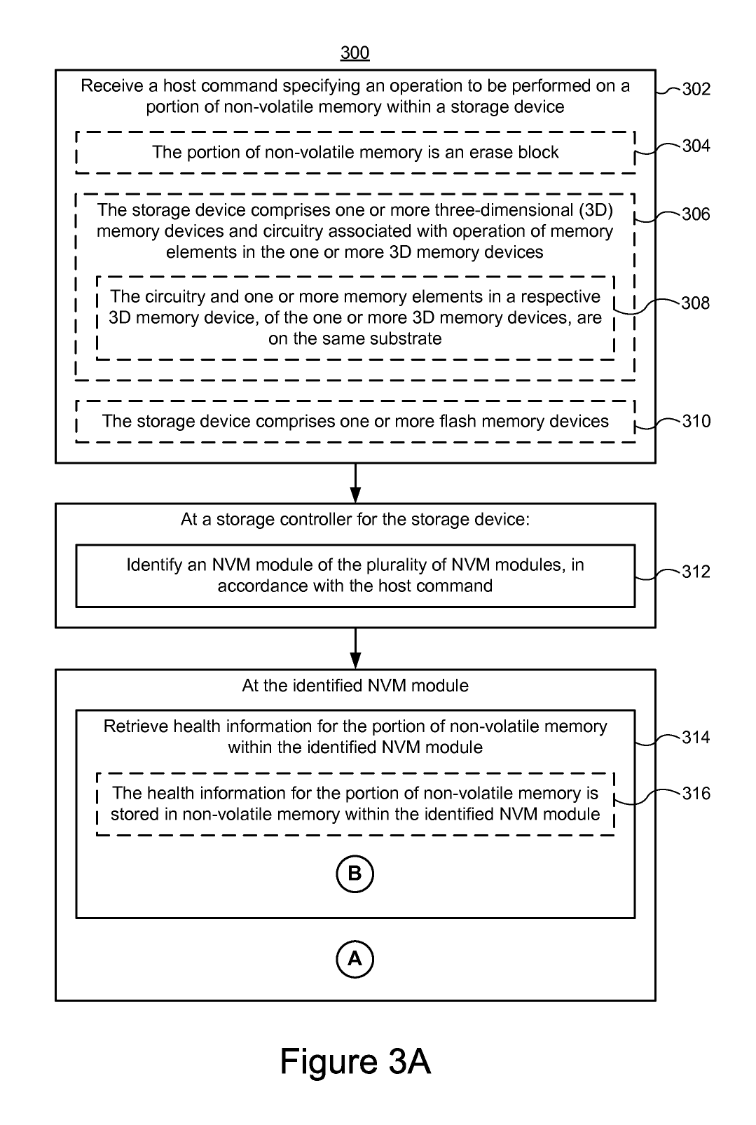

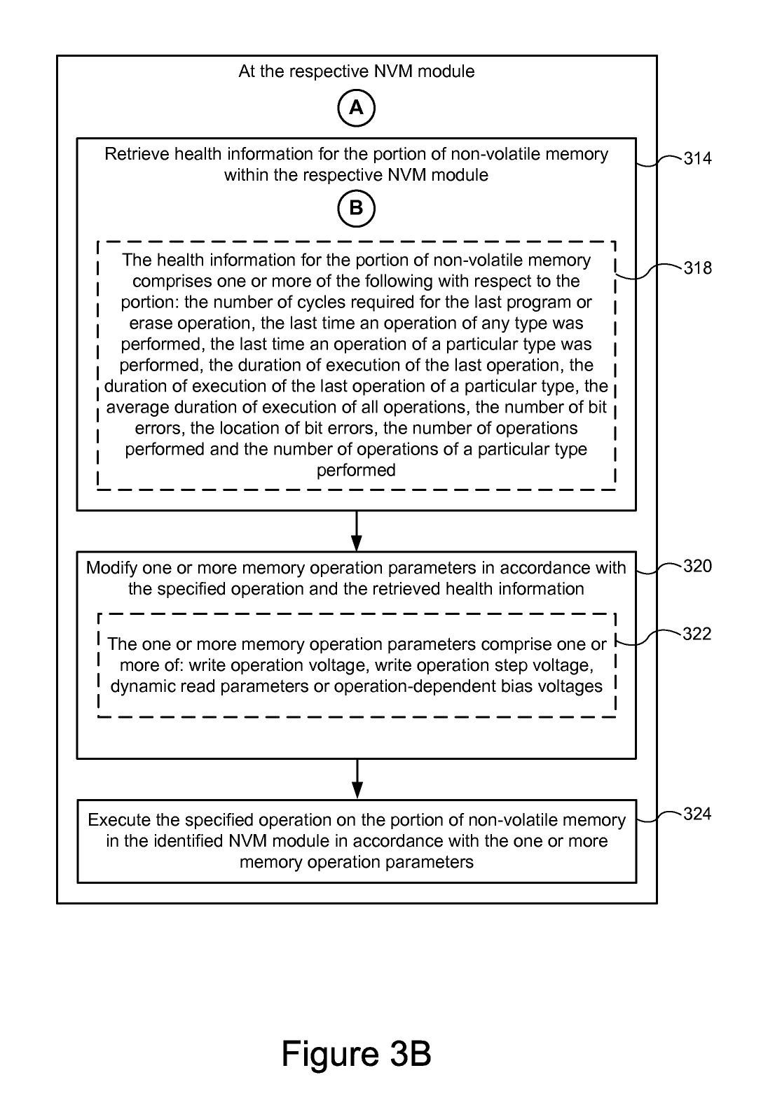

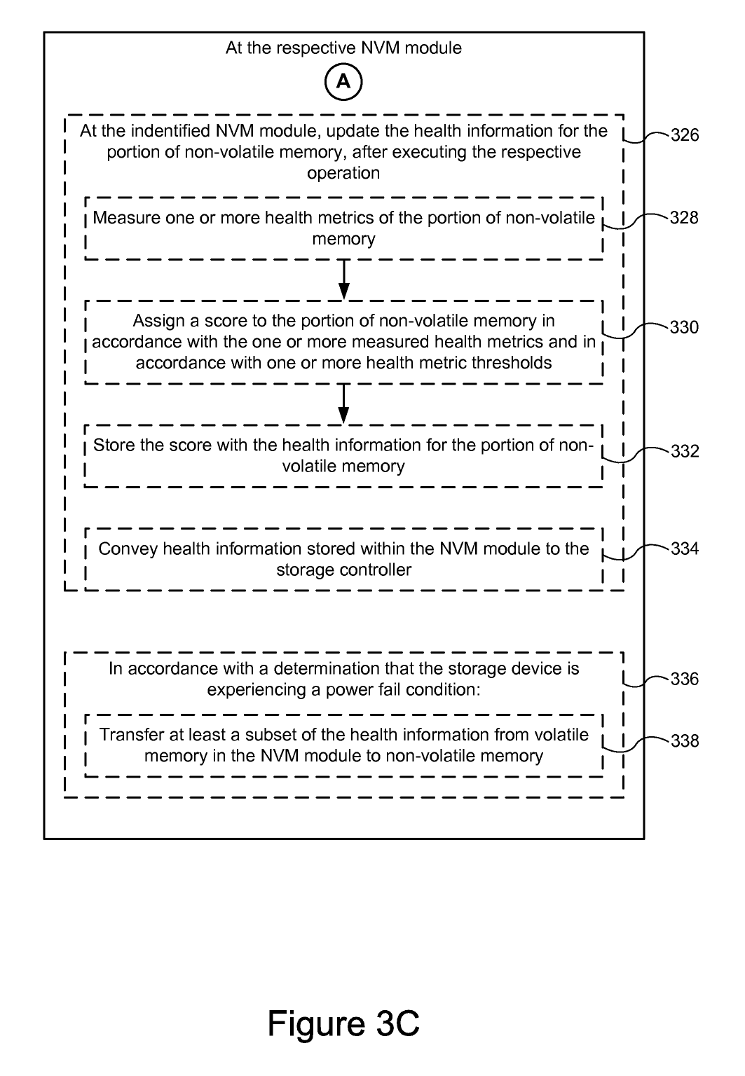

FIGS. 3A-3C contain a flowchart representation of method 300 of operating a storage device having a plurality of NVM modules, in accordance with some embodiments. At least in some implementations, method 300 is performed by a storage device (e.g., storage device 120, FIG. 1A) or one or more components of the storage device (e.g., NVM controllers 130 and/or storage device controller 128, FIG. 1B). In some embodiments, method 300 is governed by instructions that are stored in a non-transitory computer readable storage medium and that are executed by one or more processors of a device, such as storage device controller 128 and one or more NVM controllers 130, as shown in FIGS. 1B and 2A.

The method includes receiving (302) (or alternatively accessing, e.g., from a command queue) a host command that specifies an operation (e.g., reading, writing or erasing) to be performed on a portion of non-volatile memory within the storage device. For example, a storage device (e.g., storage device 120, FIG. 1A) receives (or accesses) a host command to write to a block of memory (e.g., a block of memory on one of NVM devices 140, 142). In some embodiments, the portion of non-volatile memory is (304) an erase block. In some embodiments, the portion of non-volatile memory is a portion of an erase block, such as a page or a set of pages.

In some embodiments, the storage device includes (306) one or more three-dimensional (3D) memory devices and circuitry associated with operation of memory elements in the one or more 3D memory devices. In some embodiments, the circuitry and one or more memory elements in a respective 3D memory device (308), of the one or more 3D memory devices, are on the same substrate. In some embodiments, the storage device comprises (310) one or more flash memory devices.

The method includes, at a storage controller for the storage device, identifying (312) an NVM module of the plurality of NVM modules, in accordance with the host command. For example, the storage controller (e.g., storage device controller 128, FIG. 1B) of the storage device that received (or accessed) a host command to write to a block of memory, identifies an NVM module (e.g., NVM module 160-1, FIG. 1B), for performing the write operation. In one example, the host command is a command to write data to a block of NVM memory on NVM device 140-2 (FIG. 1B), residing within NVM module 160-1 (FIG. 1B).

The method includes, at the identified NVM module, retrieving (314) health information for the portion of non-volatile memory within the identified NVM module. For example, after the storage controller (e.g., storage device controller 128, FIG. 1B), identifies NVM module 160-1 (FIG. 1B) in accordance with the write operation on a block of memory on NVM device 140-2 (FIG. 1B), NVM module 160-1 retrieves health information for the block of memory on NVM device 140-2.

In some embodiments, health information for the portion of non-volatile memory is stored (316) in non-volatile memory within the identified NVM module. For example, health information table 222 (FIG. 2A) is stored in non-volatile memory (e.g., memory 206, FIG. 2A), so that in case of a power failure condition, the information in health information table 222 is not lost. In some embodiments, the health information for the portion of non-volatile memory is stored in volatile memory, or specific forms of non-volatile memory, such as memory operating in a single-layer-cell (SLC) mode. In some embodiments, the health information for the portion of non-volatile memory is stored in byte-addressable cache memory.

In some embodiments, the health information for the portion of non-volatile memory includes (318) one or more of the following with respect to the portion: the number of cycles required for the last program or erase operation (e.g., time for an erase operation to succeed), the last time an operation of any type was performed (e.g., the last time the page was written to), the last time an operation of a particular type was performed, the duration of execution of the last operation, the duration of execution of the last operation of a particular type, the average duration of execution of all operations, the number of bit errors detected during a last read operation (or the cumulative number of bit errors detected since a predefined event), the location of bit errors, the number of memory operations (e.g., read, write and/or erase) performed and the number of operations of a particular type performed. For example, any information that relates to the reliability of a respective portion of memory to store data, is stored in the health information.

In some embodiments, health information is stored on a die-by-die basis, block-by-block basis, and/or in some embodiments, health information is stored on a page-by-page basis or a basis smaller than page-by-page. In some embodiments, health information on a certain size basis (e.g., die-by-die basis), is periodically sent from a respective NVM module to the storage controller. In some embodiments, health information for neighboring portions of memory (e.g., adjacent pages to a respective page) is also stored, updated and maintained along with health information for a respective portion of memory.

The method further includes modifying (320) one or more memory operation parameters (e.g., write voltage, read threshold) in accordance with the specified operation and the retrieved health information. For example, at NVM module 160-1 (FIG. 1B), one or more memory operation parameters are retrieved from storage (e.g., memory operation parameters 224, FIG. 2A), and modified, if necessary, in accordance with the specified operation (e.g., write operation) and the retrieved health information (e.g., the number of operations performed on the page to be written is 3000). In this example, the memory operation parameters retrieved for the write operation are an initial write voltage of 2V and a step voltage of 0.25V for incremental increases in the write voltage until data on the page has successfully been written. In this example, in accordance with a determination that the page is relatively robust due to a low number of operations performed on the page, the NVM controller of the NVM module comprising the page, lowers the initial write voltage to 1.75V and the step voltage to 0.2V to avoid unnecessarily applying too high of a voltage to this particular portion of non-volatile memory.

In some embodiments, the host command is to perform a read operation, and rather than perform a read operation at a standard, predefined voltage, by modifying one or more memory read operation parameters, a gentler read (e.g., at a lower voltage) can be performed on a respective portion of the non-volatile memory. In some embodiments, this modification results in a reduction of read disturb errors in a block comprising the page being read.

In some embodiments, the one or more memory operation parameters include (322) one or more of: write operation voltage, write operation step voltage, dynamic read parameters or operation-dependent bias voltages. In some embodiments, the memory operation parameters are predefined, standard values for the respective parameters (e.g., initial write voltage is 2V). In some embodiments, once a memory operation parameter for a respective portion of memory has been modified for a given memory operation, that modified memory operation parameter is stored with respect to the portion of memory, and retrieved for subsequent memory operations of the same type.

The method includes executing (324) the specified operation on the portion of non-volatile memory in the identified NVM module in accordance with the one or more modified memory operation parameters. For example, a write operation is performed on a page of memory on NVM device 140-2 (FIG. 1B) in accordance with the one or more modified memory operation parameters, examples of which are discussed above.

In some embodiments, the method further includes, at the identified NVM module, updating (326) the health information for the portion of non-volatile memory, after executing the specified operation. For example, after erasing a block in NVM device 140-2 (FIG. 1B), the health information for that block, and/or the health information for the pages of the block is updated to include the increased number of erase operations performed, the duration of cycles needed to perform the last erase operation and the time of performance of this erase operation.

In some embodiments, updating the health information for the portion of non-volatile memory includes measuring (328) one or more health metrics of the portion of non-volatile memory, and assigning (330) a score to the portion of non-volatile memory in accordance with the one or more measured health metrics and in accordance with one or more health metric thresholds. For example, a score between 0 and 100 is assigned to respective portions of the memory. In this example, a score of 0 is given to a completely corrupt portion of memory that cannot be recovered by ECC (error correcting code) methods, and a score of 100 is given to a new portion of memory that has had few or zero operations performed on it. In some embodiments, a score for each distinct memory operation type (e.g., read, erase, and write) is determined for each respective portion of the memory (e.g., a given block has a read score of 95, an erase score of 90 and a write score of 91). An example of assigning a score to the portion of memory, is assigning a score of 90 to a block that required 2 cycles to perform an erase operation, while the threshold for a score greater than 80 is to perform an erase operation in fewer than 3 cycles. In this example, the score of 90 is further determined after taking other health metrics and other health metric thresholds into consideration. The method further includes storing (332) the score with the health information for the portion of non-volatile memory.

In some embodiments, updating the health information for the portion of non-volatile memory after executing the specified operation includes conveying (334) some or all of the health information stored within the identified NVM module to the storage controller. In some embodiments, a particular subset of the health information stored at a identified NVM module is conveyed to the storage controller, for example, information at a die level or NVM device level, or a particular type of information such as the number of bad sectors for a respective portion of memory or a score for a respective portion of memory. In some embodiments, health information is automatically sent to the storage controller on a predefined schedule (e.g., once every hour) or another predefined basis (e.g., for every memory operation performed). In some embodiments, health information is conveyed to the storage controller in response to a request for the health information initiated by the storage controller. In some embodiments, health information is conveyed to the storage controller in response to certain trigger events, such as a firmware update, power up, power failure or a resetting of the NVM module or entire storage device.

In some embodiments, the method includes, at the identified NVM module, in accordance with a determination (336) that the storage device is experiencing a power fail condition, transferring (338) at least a subset of the health information from volatile memory in the NVM module to non-volatile memory. In some embodiments this transfer is accomplished in part through the issuance of a trigger signal or command by power failure circuitry in the NVM modules or elsewhere in the storage device (e.g., power failure circuitry 129, FIG. 1B), which signals one or more NVM controllers and/or the storage controller to transfer health information from volatile memory to non-volatile memory. In some embodiments at least a portion of the health information at the identified NVM modules does not have to be transferred to non-volatile memory during a power fail condition, because that portion of the health information is determinable upon restart (e.g., the number of cycles to erase a respective memory block). In some embodiments, the NVM modules of the storage device periodically store back-up copies in non-volatile memory of health information stored in non-volatile memory. In some embodiments, NVM modules periodically back-up portions of the health information that would otherwise be unrecoverable in the event that the health information in voltage memory were lost (e.g., the time of the last write operation on a respective portion of memory). In some embodiments, some or all of the health information stored at each NVM module is backed-up to the storage controller (e.g., storage device controller 128, FIG. 1B).

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Furthermore, each type of memory device may have different configurations. For example, flash memory devices may be configured in a NAND or a NOR configuration.

The memory devices can be formed from passive elements, active elements, or both. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles or a charge storage dielectric material.

Multiple memory elements may be configured so that they are connected in series or such that each element is individually accessible. By way of non-limiting example, NAND devices contain memory elements (e.g., devices containing a charge storage region) connected in series. For example, a NAND memory array may be configured so that the array is composed of multiple strings of memory in which each string is composed of multiple memory elements sharing a single bit line and accessed as a group. In contrast, memory elements may be configured so that each element is individually accessible, (e.g., a NOR memory array). One of skill in the art will recognize that the NAND and NOR memory configurations are exemplary, and memory elements may be otherwise configured.

The semiconductor memory elements included in a single device, such as memory elements located within and/or over the same substrate (e.g., a silicon substrate) or in a single die, may be distributed in a two- or three-dimensional manner (such as a two dimensional (2D) memory array structure or a three dimensional (3D) memory array structure).

In a two dimensional memory structure, the semiconductor memory elements are arranged in a single plane or single memory device level. Typically, in a two dimensional memory structure, memory elements are located in a plane (e.g., in an x-z direction plane) which extends substantially parallel to a major surface of a substrate that supports the memory elements. The substrate may be a wafer on which the material layers of the memory elements are deposited and/or in which memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arranged in non-regular or non-orthogonal configurations as understood by one of skill in the art. The memory elements may each have two or more electrodes or contact lines, including a bit line and a word line.

A three dimensional memory array is organized so that memory elements occupy multiple planes or multiple device levels, forming a structure in three dimensions (i.e., in the x, y and z directions, where the y direction is substantially perpendicular and the x and z directions are substantially parallel to the major surface of the substrate).

As a non-limiting example, each plane in a three dimensional memory array structure may be physically located in two dimensions (one memory level) with multiple two dimensional memory levels to form a three dimensional memory array structure. As another non-limiting example, a three dimensional memory array may be physically structured as multiple vertical columns (e.g., columns extending substantially perpendicular to the major surface of the substrate in the y direction) having multiple elements in each column and therefore having elements spanning several vertically stacked planes of memory devices. The columns may be arranged in a two dimensional configuration (e.g., in an x-z plane), thereby resulting in a three dimensional arrangement of memory elements. One of skill in the art will understand that other configurations of memory elements in three dimensions will also constitute a three dimensional memory array.

By way of non-limiting example, in a three dimensional NAND memory array, the memory elements may be connected together to form a NAND string within a single plane, sometimes called a horizontal (e.g., x-z) plane for ease of discussion. Alternatively, the memory elements may be connected together to extend through multiple parallel planes. Other three dimensional configurations can be envisioned wherein some NAND strings contain memory elements in a single plane of memory elements (sometimes called a memory level) while other strings contain memory elements which extend through multiple parallel planes (sometimes called parallel memory levels). Three dimensional memory arrays may also be designed in a NOR configuration and in a ReRAM configuration.

A monolithic three dimensional memory array is one in which multiple planes of memory elements (also called multiple memory levels) are formed above and/or within a single substrate, such as a semiconductor wafer, according to a sequence of manufacturing operations. In a monolithic 3D memory array, the material layers forming a respective memory level, such as the topmost memory level, are located on top of the material layers forming an underlying memory level, but on the same single substrate. In some implementations, adjacent memory levels of a monolithic 3D memory array optionally share at least one material layer, while in other implementations adjacent memory levels have intervening material layers separating them.

In contrast, two dimensional memory arrays may be formed separately and then integrated together to form a non-monolithic 3D memory device in a hybrid manner. For example, stacked memories have been constructed by forming 2D memory levels on separate substrates and integrating the formed 2D memory levels atop each other. The substrate of each 2D memory level may be thinned or removed prior to integrating it into a 3D memory device. As the individual memory levels are formed on separate substrates, the resulting 3D memory arrays are not monolithic three dimensional memory arrays.

Associated circuitry is typically required for proper operation of the memory elements and for proper communication with the memory elements. This associated circuitry may be on the same substrate as the memory array and/or on a separate substrate. As non-limiting examples, the memory devices may have driver circuitry and control circuitry used in the programming and reading of the memory elements.

Further, more than one memory array selected from 2D memory arrays and 3D memory arrays (monolithic or hybrid) may be formed separately and then packaged together to form a stacked-chip memory device. A stacked-chip memory device includes multiple planes or layers of memory devices, sometimes called memory levels.

The term “three-dimensional memory device” (or 3D memory device) is herein defined to mean a memory device having multiple layers or multiple levels (e.g., sometimes called multiple memory levels) of memory elements, including any of the following: a memory device having a monolithic or non-monolithic 3D memory array, some non-limiting examples of which are described above; or two or more 2D and/or 3D memory devices, packaged together to form a stacked-chip memory device, some non-limiting examples of which are described above.

A person skilled in the art will recognize that the invention or inventions descried and claimed herein are not limited to the two dimensional and three dimensional exemplary structures described here, and instead cover all relevant memory structures suitable for implementing the invention or inventions as described herein and as understood by one skilled in the art.

It will be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

What is claimed is:

1. A method of performing operations in a storage device having a plurality of NVM modules, comprising:
processing a host command, the host command specifying an operation to be performed on a portion of non-volatile memory within the storage device, by:
at a storage controller for the storage device:
identifying an NVM module of the plurality of NVM modules, in accordance with the host command;
at the identified NVM module:
retrieving health information for the portion of non-volatile memory within the identified NVM module;
modifying one or more memory operation parameters in accordance with the specified operation and the retrieved health information; and
executing the specified operation on the portion of non-volatile memory in the identified NVM module in accordance with the one or more modified memory operation parameters.

2. The method of claim 1, further comprising, at the identified NVM module:
updating the health information for the portion of non-volatile memory, after executing the specified operation.

3. The method of claim 2, wherein updating the health information for the portion of non-volatile memory comprises:
measuring one or more health metrics of the portion of non-volatile memory;
assigning a score to the portion of non-volatile memory in accordance with the one or more measured health metrics and in accordance with one or more health metric thresholds; and
storing the score with the health information for the portion of non-volatile memory.

4. The method of claim 1, further comprising, at the identified NVM module:
conveying health information stored within the NVM module to the storage controller.

5. The method of claim 1, wherein the health information for the portion of non-volatile memory comprises one or more of the following with respect to the portion: the number of cycles required for the last program or erase operation, the last time an operation of any type was performed, the last time an operation of a particular type was performed, the duration of execution of the last operation, the duration of execution of the last operation of a particular type, the average duration of execution of all operations, the number of bit errors, the location of bit errors, the number of operations performed and the number of operations of a particular type performed.

6. The method of claim 1, wherein the one or more memory operation parameters comprise one or more of: write operation voltage, write operation step voltage, dynamic read parameters or operation-dependent bias voltages.

7. The method of claim 1, wherein the health information for the portion of non-volatile memory is stored in non-volatile memory within the NVM module.

8. The method of claim 1, wherein the portion of non-volatile memory is an erase block.

9. The method of claim 1, further comprising, at the identified NVM module:
in accordance with a determination that the storage device is experiencing a power fail condition:
transferring at least a subset of the health information from volatile memory in the NVM module to non-volatile memory.

10. The method of claim 1, wherein the storage device comprises one or more flash memory devices.

11. A storage device, comprising:
an interface for coupling the storage device to a host system; and
a storage controller having one or more processors, the storage controller configured to:
receive or access a host command specifying an operation to be performed on a portion of non-volatile memory within the storage device;
identify an NVM module of the plurality of NVM modules, in accordance with the host command;
an NVM module having one or more processors, the NVM module configured to:
retrieve health information for the portion of non-volatile memory within the identified NVM module;
modify one or more memory operation parameters in accordance with the specified operation and the retrieved health information; and
execute the specified operation on the portion of non-volatile memory in the identified NVM module in accordance with the one or more modified memory operation parameters.

12. The storage device of claim 11, wherein the NVM module is further configured to:
update the health information for the portion of non-volatile memory, after executing the specified operation.

13. The storage device of claim 12, wherein updating the health information for the portion of non-volatile memory comprises the NVM module being further configured to:
measure one or more health metrics of the portion of non-volatile memory;
assign a score to the portion of non-volatile memory in accordance with the one or more measured health metrics and in accordance with one or more health metric thresholds; and
store the score with the health information for the portion of non-volatile memory.

14. The storage device of claim 11, wherein the NVM module is further configured to:
convey health information stored within the NVM module to the storage controller.

15. The storage device of claim 11, wherein the health information for the portion of non-volatile memory comprises one or more of the following with respect to the portion: the number of cycles required for the last program or erase operation, the last time an operation of any type was performed, the last time an operation of a particular type was performed, the duration of execution of the last operation, the duration of execution of the last operation of a particular type, the average duration of execution of all operations, the number of bit errors, the location of bit errors, the number of operations performed and the number of operations of a particular type performed.

16. The storage device of claim 11, wherein the one or more memory operation parameters comprise one or more of: write operation voltage, write operation step voltage, dynamic read parameters or operation-dependent bias voltages.

17. The storage device of claim 11, wherein the health information for the portion of non-volatile memory is stored in non-volatile memory within the NVM module.

18. The storage device of claim 11, wherein the portion of non-volatile memory is an erase block.

19. The storage device of claim 11, wherein the NVM module is further configured to:
in accordance with a determination that the storage device is experiencing a power fail condition:
transfer at least a subset of the health information from volatile memory in the NVM module to non-volatile memory.

20. The storage device of claim 11, wherein the storage device comprises one or more flash memory devices.

21. A storage device, comprising:
an interface for coupling the storage device to a host system;
a plurality of NVM modules, each NVM module including two or more non-volatile memory devices; and
a storage controller having one or more processors, the storage controller including:
a command module to receive or access a host command specifying an operation to be performed on a portion of non-volatile memory within the storage device; and
a map module to identify an NVM module of the plurality of NVM modules, in accordance with the host command;
the identified NVM module including:
a health management module for retrieving health information for the portion of non-volatile memory within the identified NVM module;
a memory operation configuration module to modify one or more memory operation parameters in accordance with the specified operation and the retrieved health information; and
an execution module to execute the specified operation on the portion of non-volatile memory, in the identified NVM module, in accordance with the one or more modified memory operation parameters.
